(19) United States
(12) Patent Application Publication
(10) Pub. No.: US 2022/0251285 A1
(43) Pub. Date: Aug. 11, 2022

(54) CURABLE COMPOSITION, CURED PRODUCT, FIBER-REINFORCED COMPOSITE MATERIAL, AND MOLDED ARTICLE

(71) Applicant: DIC Corporation, Tokyo (JP)

(72) Inventors: Atsuko Kobayashi, Ichihara-shi (JP); Makoto Kimura, Ichihara-shi (JP); Shigeki Matsui, Ichihara-shi (JP)

(73) Assignee: DIC Corporation, Tokyo (JP)

(21) Appl. No.: 17/628,599

(22) PCT Filed: Jul. 30, 2020
(86) PCT No.: PCT/JP2020/029181

§ 371 Date: Jan. 20, 2022

(30) Foreign Application Priority Data
Aug. 6, 2019 (JP) 2019-144483

(51) Int. Cl. C08G 59/20; C08G 59/42; C08J 5/04

(52) U.S. Cl. CPC C08G 59/20; C08G 18/48; C08J 5/04; C08G 59/42

(57) ABSTRACT

The present invention provides a curable composition containing a urethane-modified epoxy resin (A) as an essential component of a main agent and an acid anhydride (B) as an essential component of a curing agent, the urethane-modified epoxy resin (A) being a reaction product obtained by using a polyisocyanate compound (a1), a polyether polyol (a2), and a hydroxy group-containing epoxy resin (a3) as essential reaction materials; a cured product thereof; a fiber-reinforced composite material; a fiber-reinforced resin molded article; and a method for producing a fiber-reinforced resin molded article. The curable composition can form a cured product having excellent fracture toughness and tensile strength in the cured product.

### TECHNICAL FIELD

The present invention relates to a curable composition that provides a cured product excellent in fracture toughness and tensile strength and a cured product thereof, and also relates to a fiber-reinforced composite material, a fiber-reinforced resin molded article, and a method for producing a fiber-reinforced resin molded article.

### BACKGROUND ART

A fiber-reinforced resin molded article reinforced with a reinforcing fiber attracts attention due to the characteristics of being excellent in mechanical strength while having a light weight, and the use thereof has been expanded to the application to housings or various members of vehicles, aircrafts, ships, and the like, and to various structures. Such a fiber-reinforced resin molded article can be produced by molding a fiber-reinforced composite material by a molding method, such as a filament winding method, a press-molding method, a hand lay-up method, a pultrusion method, or an RTM method.

The fiber-reinforced composite material is obtained by infiltrating a resin into a reinforcing fiber. Since a resin used in a fiber-reinforced composite material is required to have stability at normal temperature and to provide a cured product having durability and strength, a thermosetting resin is generally used in many cases. In addition, since a resin is used by infiltrating the resin into a reinforcing fiber as described above, a resin having lower viscosity in an infiltration step is more preferred.

Furthermore, the properties required for the resin also depend on the use purpose of the fiber-reinforced resin molded article. For example, when the fiber-reinforced resin molded article is used in a structure component, such as an engine, or in an electric wire core material, a resin that provides a cured product excellent in thermal resistance and mechanical strength is demanded so that the fiber-reinforced resin molded article endures a tough usage environment for a long period of time. Alternatively, when the fiber-reinforced resin molded article is used for reinforcing a high-pressure tank, cycling characteristics involved in the charging and discharging of high-pressure gas are required, and therefore, it is required to provide a cured product excellent in fracture toughness, elongation, and other characteristics.

As a resin composition for a fiber-reinforced composite material, for example, an epoxy resin composition containing a main agent that contains a bisphenol-type epoxy resin and a curing agent that contains an acid anhydride is widely known (see, for example, PTL 1). Such an epoxy resin composition has characteristics of having high infiltration ability into a reinforcing fiber and providing a cured product excellent in thermal resistance and the like, but has not been sufficient in mechanical strength which is evaluated by a fracture toughness test or a tensile strength test.

### CITATION LIST

### Patent Literature

PTL 1: JP-A-2010-163573

### SUMMARY OF INVENTION

### Technical Problem

Accordingly, a problem that the present invention is to solve is to provide a curable composition that provides a cured product excellent in fracture toughness and tensile strength and a cured product thereof, and to provide a fiber-reinforced composite material, a fiber-reinforced resin molded article, and a method for producing a fiber-reinforced resin molded article.

### Solution to Problem

As a result of extensive and intensive studies for solving the above problem, the present inventors have found that the problem can be solved by using, as an epoxy resin component, a urethane-modified epoxy resin obtained by using a polyisocyanate compound, a polyether polyol, and a hydroxy group-containing epoxy resin as essential reaction materials, and as a curing agent, an acid anhydride, thus completing the present invention.

Specifically, the present invention provides a curable composition that contains a urethane-modified epoxy resin (A) as an essential component of a main agent and an acid anhydride (B) as an essential component of a curing agent, the urethane-modified epoxy resin (A) being a reaction product obtained by using a polyisocyanate compound (a1), a polyether polyol (a2), and a hydroxy group-containing epoxy resin (a3) as essential reaction materials; a cured product thereof; a fiber-reinforced composite material and a fiber-reinforced resin molded article obtained by using the curable composition; and a method for producing a fiber-reinforced resin molded article.

### Advantageous Effects of Invention

According to the present invention, it is possible to provide a curable composition that provides a cured product excellent in fracture toughness and tensile strength, a cured product thereof, a fiber-reinforced composite material, a fiber-reinforced resin molded article, and a method for producing a fiber-reinforced resin molded article.

### DESCRIPTION OF EMBODIMENTS

The curable composition of the present invention is a curable composition that contains a urethane-modified epoxy resin (A) as an essential component of a main agent and an acid anhydride (B) as an essential component of a curing agent, the urethane-modified epoxy resin (A) being a reaction product obtained by using a polyisocyanate compound (a1), a polyether polyol (a2), and a hydroxy group-containing epoxy resin (a3) as essential reaction materials.

Examples of the polyisocyanate compound (a1) which is a reaction material of the urethane-modified epoxy resin (A) include an aliphatic diisocyanate compound, such as butane diisocyanate, hexamethylene diisocyanate, 2,2,4-trimethylhexamethylene diisocyanate, or 2,4,4-trimethylhexamethylene diisocyanate; an alicyclic diisocyanate compound, such as norbornane diisocyanate, isophorone diisocyanate, hydrogenated xylylene diisocyanate, or hydrogenated diphenylmethane diisocyanate; an aromatic diisocyanate compound, such as tolylene diisocyanate, xylylene diisocyanate, tetramethylxylylene diisocyanate, diphenylmethane diisocyanate, or 1,5-naphthalene diisocyanate; a polymethylene polyphenyl polyisocyanate having a repeating structure represented by the following structural formula (1); and an isocyanurate modified form, a biuret modified form, and an allophanate modified form thereof. One of the polyisocyanate compounds may be used alone or two or more thereof may be used in combination.

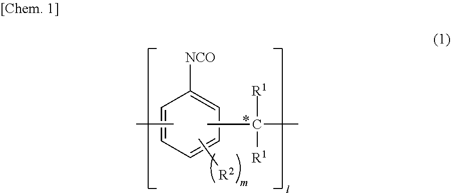

[In the formula, R¹'s are each independently a hydrogen atom or a hydrocarbon group having 1 to 6 carbon atoms. R²'s are each independently an alkyl group having 1 to 4 carbon atoms or a binding point that binds to a structural moiety represented by the structural formula (1) via the methylene group with *. m is 0 or an integer of 1 to 3 and 1 is an integer of 1 or more.]

Among the polyisocyanate compounds (a1), since a curable composition that provides a cured product having high fracture toughness and high tensile strength and that is also excellent in infiltration ability into a reinforcing fiber is obtained, various diisocyanate compounds are preferred, and a diisocyanate compound having a ring structure in the molecular structure, that is, an alicyclic diisocyanate or an aromatic diisocyanate is more preferred. Furthermore, one having an isocyanate group content of 35% by mass or higher is particularly preferred. When two or more polyisocyanate compounds (al) are used in combination, 80% by mass or more thereof is preferably occupied by a diisocyanate compound, and 80% by mass or more thereof is more preferably occupied by an alicyclic diisocyanate or an aromatic diisocyanate.

Examples of the polyether polyol (a2) include a bifunctional polyether diol and a tri- or higher functional polyether polyol.

The polyether diol is preferably a compound that has an oxyalkylene group and has two hydroxy groups per molecule at any position, such as a polymer terminal or a branched chain terminal, in the molecule.

Examples of such a polyether diol include, but are not limited to, bifunctional polyalkylene oxides, such as polyoxypropylene glycol, polyoxyethylene glycol, poly(oxypropylene-oxyethylene)diol, and polytetramethylene ether glycol. The polyether diols can be produced, for example, by subjecting an alkylene oxide to ring-opening polymerization using a bifunctional initiator in the presence of a ring-opening polymerization catalyst. The ring-opening polymerization catalyst is not particularly limited, and examples thereof include an alkali metal compound catalyst, such as potassium hydroxide or sodium hydroxide; a cesium metal compound catalyst, such as cesium hydroxide; a composite metal cyanide complex catalyst, such as zinc hexacyanocobaltate complex; a phosphazene catalyst; an imino group-containing phosphazenium salt catalyst; and a barium hydroxide catalyst. One of the catalysts or two or more thereof may be used.

A commercial product may also be used as it is, and specific examples thereof include SANNIX PP-1000, PP-2000, PP-3000, and PP-4000 manufactured by Sanyo Chemical Industries Ltd., ACTCOL P-22, P-21, P-23, P-28, and ED-28 manufactured by Mitsui Chemicals Inc., EXCENOL 720, 1020, 2020, 3020, 4020, 510, 4002, 4010, 4019, 5001, and 5005, PREMINOL 4002 and 5005 and PREMINOL 54004, 4011, 4012, 4015, 4008F, 4013F, and 4318F manufactured by AGC Inc., UNIOL D-1000, D-1200, D-2000, D-4000, and PB-700, PEG#1500, PEG#2000, and PRONON #102, #104, #202B, and #204 manufactured by NOF CORPORATION, and PTMG650, PTMG1000, PTMG1500, and PTMG2000 manufactured by Mitsubishi Chemical Corporation. The polyether diols may each be used alone or two or more thereof may be used in mixture. Among them, from the viewpoint of excellent fracture toughness, one having an oxypropylene group or a tetramethylene ether group is preferred.

In addition, the polyether diol preferably has a number average molecular weight (Mn) in the range of 500 to 4,000, more preferably in the range of 1,000 to 3,000. Note that the number average molecular weight is calculated based on the hydroxyl value of the polyether diol (a value measured according to JIS K1557 6.4, OHV, the unit is mgKOH/g).

The tri- or higher functional polyether polyol has an oxyalkylene group and has at least three or more hydroxy groups per molecule at any position, such as a polymer terminal or a branched chain terminal, in the molecule.

Examples thereof include, but are not limited to, tri-or higher functional polyalkylene oxides, such as polyoxypropylene polyol, polyoxyethylene polyol, and poly(oxypropylene-oxyethylene) polyol, which are specifically available as commercial products, such as SANNIX GP-400, GP-600, GP-1000, GP-1500, GP-3000, GP-4000V, GA-50005, FA-908, FA-961, FA-921, FA-703, or FA-757 manufactured by Sanyo Chemical Industries Ltd., ACTCOL G-28, MN-5000, MN-4000, P-31, or MN-1500 manufactured by Mitsui Chemicals Inc., EXCENOL 1030, 4030, 5030, 230, 828, or 837, PREMINOL 3005, 3010, 3015, 3020, 7001, 7006, or 7012, PREMINOL 53006 or 3011, or PREMINOL 7021 (tetrafunctional) manufactured by AGC Inc.

The tri- or higher functional polyether polyol preferably has a number of hydroxy groups per molecule in the range of 3 to 6, and further preferably in the range of 3 to 4.

The tri- or higher functional polyether polyol preferably has a number average molecular weight (Mn) in the range of 500 to 4,000, and particularly preferably in the range of 1,000 to 3,000. Note that the number average molecular weight is calculated based on the hydroxyl value in the same manner as in the polyether diol.

Among them, since a curable composition that provides a cured product having high fracture toughness and high tensile strength and that is also excellent in infiltration ability into a reinforcing fiber is obtained, the polyether diol is preferred. When two or more polyether polyols (a2) are used, the polyether diol content in the polyether polyols (a2) is preferably 80% by mass or more.

The hydroxy group-containing epoxy resin (a3) is not particularly limited as long as it has a hydroxy group and a glycidyl group in the molecular structure. In addition, one hydroxy group-containing epoxy resin (a3) may be used alone or two or more hydroxy group-containing epoxy resins (a3) may be used in combination. Among them, since a curable composition that provides a cured product having high fracture toughness and high tensile strength and that is also excellent in infiltration ability into a reinforcing fiber is obtained, a bifunctional hydroxy group-containing epoxy resin obtained by converting a diol compound into a glycidyl ether is preferred.

A theoretical structure of the bifunctional hydroxy group-containing epoxy resin is represented, for example, by the following structural formula (2).

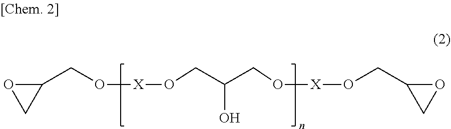

(In the formula, X is a structural moiety derived from a diol compound, n is 0 or an integer of 1 or more, and the average of n is a value exceeding 0.)

Examples of the diol compound include an aliphatic diol compound, such as ethylene glycol, propylene glycol, 1,3-propanediol, 2-methylpropanediol, 1,2,2-trimethyl-1,3-propanediol, 2,2-dimethyl-3-isopropyl-1,3-propanediol, 1,4-butanediol, 1,3-butanediol, 3-methyl-1,3-butanediol, 1,5-pentanediol, 3-methyl-1,5-pentanediol, neopentylglycol, 1,6-hexanediol, 1,4-bis(hydroxymethyl)cyclohexane, or 2,2,4-trimethyl-1,3-pentane diol; an aromatic diol compound, such as biphenol, tetramethylbiphenol, bisphenol A, bisphenol AP, bisphenol B, bisphenol BP, bisphenol C, bisphenol E, bisphenol F, or bisphenol S.

Among them, since a curable composition that provides a cured product excellent not only in fracture toughness and tensile strength but also in thermal resistance and the like is obtained, an aromatic bifunctional hydroxy group-containing epoxy resin obtained by using the aromatic diol compound is preferably used. When two or more compounds are used in combination as the hydroxy group-containing epoxy resin (a3), the proportion of the aromatic bifunctional hydroxy group-containing epoxy resin based on the total mass of the hydroxy group-containing epoxy resins (a3) is preferably 35% by mass or more, and more preferably in the range of 40 to 90% by mass.

The epoxy equivalent of the hydroxy group-containing epoxy resin (a3) is preferably in the range of 100 to 400 g/equivalent, and more preferably in the range of 100 to 250 g/equivalent. In addition, the hydroxy group equivalent is more preferably in the range of 600 to 3500 g/equivalent.

In the invention of the present application, the hydroxy group equivalent of the hydroxy group-containing epoxy resin (a3) is measured by the following method.

1. About 100 g of the hydroxy group-containing epoxy resin (a3) and 25 mL of anhydrous dimethylformaldehyde were added into a flask and were dissolved.
2. About 30 mg of dibutyltin laurate and 20 mL of a phenyl isocyanate anhydrous toluene solution (1 mol/L) were added, and the flask was immersed in a hot water bath of 50° C. and the mixture was stirred for 60 minutes.
3. 20 mL of a dibutylamine anhydrous toluene solution (2 mol/L) was added thereto and the mixture was stirred at room temperature for 30 minutes.
4. 30 mL of methyl cellosolve and 0.5 mL of bromocresol green indicator were added thereto and titration was performed with a perchloric acid methyl cellosolve solution (1 mol/L). At the same time, a blank measurement was also performed.
5. The hydroxy group equivalent of the hydroxy group-containing epoxy resin (a3) was calculated by the following calculation formula.

$$( Hydroxy group equivalent ( g / equivalent ) ) = 1000 \times ( amount of sample of hydroxy group - contain ing epoxy resin ( a 3 ) [ g ] ) / [ ( concentration of perchloric acid methyl cellosolve solution [ 1 mol / L ] ) \times \{ ( titer for hydroxy group - containing epoxy resin ( a 3 ) solution [ mL ] ) - ( titer for blank [ mL ) \} ]$$

The urethane-modified epoxy resin (A) is obtained by using the polyisocyanate compound (a1), the polyether polyol (a2), and the hydroxy group-containing epoxy resin (a3) as essential reaction materials, but a reaction material other than those may be used together. Examples of the other reaction material include an aliphatic polyol, an aromatic polyol, a polyester polyol, a polyolefin-type polyol, and a polycarbonate polyol. When the other reaction material is used, since the effect of the present invention of providing a cured product excellent in fracture toughness and tensile strength is sufficiently achieved, the total mass of the polyisocyanate compound (a1), the polyether polyol (a2), and the hydroxy group-containing epoxy resin (a3) based on the total mass of the reaction materials of the urethane-modified epoxy resin (A) is preferably 70% by mass or more and more preferably 90% by mass or more.

The method for producing the urethane-modified epoxy resin (A) is not limited as long as the polyisocyanate compound (a1), the polyether polyol (a2), and the hydroxy group-containing epoxy resin (a3) are used as essential reaction materials, and the urethane-modified epoxy resin (A) may be produced by any method. Examples of the production method include the following methods.

Method 1: a method in which all the reaction materials are put in a vessel at once and are reacted.
Method 2: a method in which the polyisocyanate compound (a1), the polyether polyol (a2), and another polyol compound which is used as required are reacted to obtain an isocyanate group-containing intermediate, and then, the hydroxy group-containing epoxy resin (a3) is reacted therewith.
Method 3: a method in which the polyisocyanate compound (a1) and the acid group-containing epoxy resin (a3) are reacted to obtain an isocyanate group-containing intermediate, and then, the polyether polyol (a2) and another polyol compound which is used as required are reacted therewith
Method 4: the polyisocyanate compound (a1), a part or all of the polyether polyol (a2), a part or all of the hydroxy group-containing epoxy resin (a3), and a part or all of another polyol compound which is used as required are reacted to obtain an isocyanate group-containing intermediate, and then, the rest of the polyether polyol (a2), the hydroxy group-containing epoxy resin (a3), and the other polyol compound are reacted therewith

In any of the methods 1 to 4, the molar ratio of isocyanate groups to hydroxy groups [(NCO)/(OH)] in the reaction materials is preferably in the range of 1/0.95 to 1/5.0 since a curable composition excellent in storage stability and the like is obtained.

Furthermore, the molar ratio of isocyanate groups in the reaction materials to hydroxy groups in the polyether polyol (a2) [(NCO)/(OH)] is preferably in the range of 1/0.4 to 1/0.7 and more preferably in the range of 1/0.55 to 1/0.70 since a cured product excellent in fracture toughness is obtained.

In addition, since the effect of providing a cured product excellent in fracture toughness and tensile strength is more significantly achieved, the proportion of the polyether polyol (a2) based on the total mass of the reaction materials is preferably in the range of 5 to 50% by mass, and more preferably in the range of 15 to 35% by mass.

The epoxy equivalent of the urethane-modified epoxy resin (A) is preferably in the range of 150 to 300 g/equivalent since a curable composition that provides a cured product excellent in fracture toughness and tensile strength and that is also excellent in curability, infiltration ability into a reinforcing fiber, and the like is obtained.

A main agent in the curable composition of the present invention may contain a component other than the urethane-modified epoxy resin (A). An example of the other component is an epoxy resin other than the urethane-modified epoxy resin (A).

Examples of the other epoxy resin include diglycidyloxybenzene, diglycidyloxynaphthalene, an aliphatic epoxy resin, a biphenol-type epoxy resin, a bisphenol-type epoxy resin, a novolac-type epoxy resin, a triphenolmethane-type epoxy resin, a tetraphenolethane-type epoxy resin, a phenol or naphthol aralkyl-type epoxy resin, a phenylene or naphthylene ether-type epoxy resin, a dicyclopentadiene-phenol adduct-type epoxy resin, a phenolic hydroxy group-containing compound-alkoxy group-containing aromatic compound cocondensed epoxy resin, a glycidylamine-type epoxy resin, and a naphthalene skeleton-containing epoxy resin other than the above.

Examples of the aliphatic epoxy resin include glycidyl ethers produced from various aliphatic polyol compounds. One of the aliphatic epoxy resins may be used alone or two or more thereof may be used in combination. Examples of the aliphatic polyol compound include an aliphatic diol compound, such as ethylene glycol, propylene glycol, 1,3-propanediol, 2-methylpropanediol, 1,2,2-trimethyl-1,3-propanediol, 2,2-dimethyl-3-isopropyl-1,3-propanediol, 1,4-butanediol, 1,3-butanediol, 3-methyl-1,3-butanediol, 1,5-pentanediol, 3-methyl-1,5-pentanediol, neopentylglycol, 1,6-hexanediol, 1,4-bis(hydroxymethyl)cyclohexane, or 2,2,4-trimethyl-1,3-pentanediol; and a tri- or higher functional aliphatic polyol compound, such as trimethylolethane, trimethylolpropane, glycerol, hexanetriol, pentaerythritol, ditrimethylolpropane, or dipentaerythritol.

Examples of the biphenol-type epoxy resin include a polyglycidyl ether obtained by reacting a biphenol compound, such as biphenol or tetramethylbiphenol, with epihalohydrin. Among them, one having an epoxy equivalent in the range of 150 to 200 g/eq is preferred.

Examples of the bisphenol-type epoxy resin include a polyglycidyl ether obtained by reacting a bisphenol compound, such as bisphenol A, bisphenol F, or bisphenol S, with epihalohydrin. Among them, one having an epoxy equivalent in the range of 158 to 200 g/eq is preferred.

An example of the novolac-type epoxy resin is a polyglycidyl ether obtained by reacting a novolac resin containing one or two or more of various phenol compounds, such as phenol, cresol, naphthol, bisphenol, and biphenol, with epihalohydrin.

An example of the triphenolmethane-type epoxy resin is one having a structural moiety represented by the following structural formula (3) as a repeating structure.

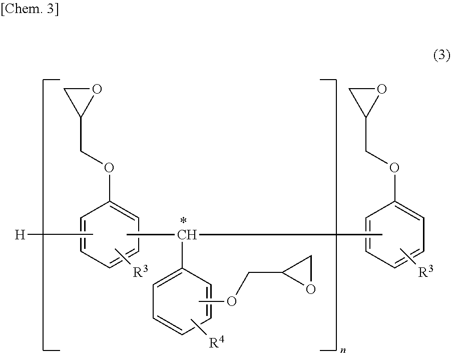

[In the formula, R³ and R⁴ are each independently a hydrogen atom or a binding point that binds to the structural moiety represented by structural formula (3) via the methine group with *. n is an integer of 1 or more.]

An example of the phenol or naphthol aralkyl-type epoxy resin is one having a molecular structure in which glycidyloxybenzene or glycidyloxynaphthalene structures are linked via a structural moiety represented by any one of the following structural formulae (4-1) to (4-3).

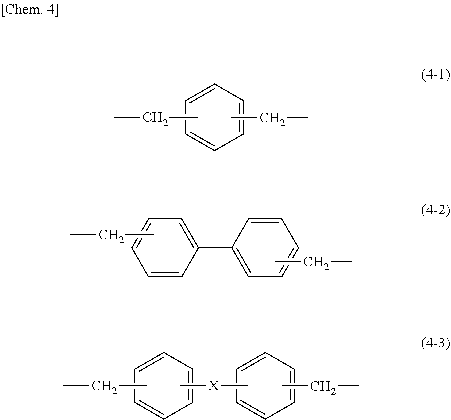

(In the formula, X is any one of an alkylene group having 2 to 6 carbon atoms, an ether bond, a carbonyl group, a carbonyloxy group, a sulfide group, or a sulfone group.]

An example of the naphthalene skeleton-containing epoxy resin is an epoxy compound represented by any one of the following structural formulae (5-1) to (5-3).

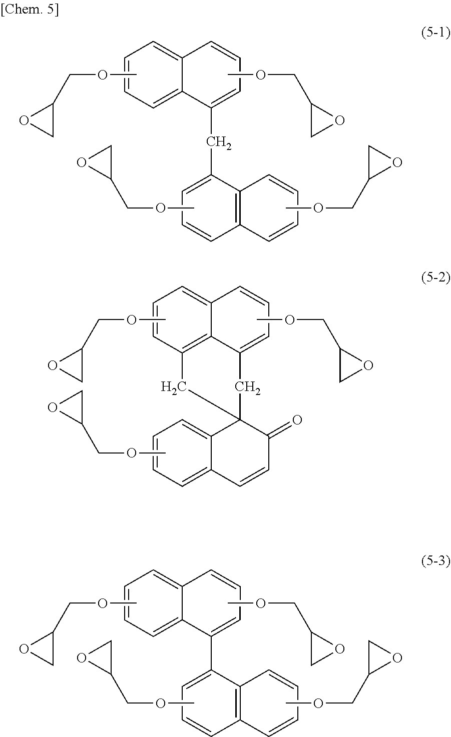

Among the other epoxy resins, because of providing a cured product having high fracture toughness and high tensile strength and being excellent in infiltration ability into a reinforcing fiber, any one of an aliphatic epoxy resin, a bisphenol-type epoxy resin, a triphenolmethane-type epoxy resin, a glycidylamine-type epoxy resin, and a naphthalene skeleton-containing epoxy resin is preferred, and an aliphatic epoxy resin or a bisphenol-type epoxy resin is more preferred, and an aliphatic epoxy resin is particularly preferred.

The content of each epoxy resin in the main agent is not particularly limited, and can be appropriately adjusted depending on the desired properties and use purpose. More preferably, the proportion of the urethane-modified epoxy resin (A) based on the total mass of the epoxy resin components is preferably in the range of 30 to 100% by mass. When an aliphatic epoxy resin is used as the other epoxy resin, the mass ratio thereof [urethane-modified epoxy resin (A)/aliphatic epoxy resin] is preferably in the range of 30/70 to 100/0.

The curing agent in the curable composition of the present invention contains the acid anhydride (B) as an essential component. One acid anhydride (B) may be used alone or two or more acid anhydrides (B) may be used in combination. Specific examples of the acid anhydride (B) include tetrahydrophthalic anhydride, methyltetrahydrophthalic anhydride, hexahydrophthalic anhydride, methylhexahydrophthalic anhydride, methyl-end-ethylene tetrahydrophthalic anhydride, trialkyltetrahydrophthalic anhydride, methylnadic anhydride, phthalic anhydride, trimellitic anhydride, pyromellitic anhydride, and maleic anhydride. Among them, methyltetrahydrophthalic anhydride, methylhexahydrophthalic anhydride, or methyl-end-ethylene tetrahydrophthalic anhydride is more preferably used from the viewpoint of infiltration ability into a reinforcing fiber.

In the present invention, in addition to the acid anhydride (B), a curing agent or curing promotor (B′) other than the acid anhydride (B) may be used. As the other curing agent or curing promotor (B′), one which is generally used as a curing promotor for an epoxy resin and an acid anhydride can be used also in the present invention. Specific examples thereof include an imidazole derivative, a tertiary amine, an amine complex salt, an amide compound, a phenolic hydroxy group-containing compound or a phenol resin, a phosphoric compound, a urea derivative, an organic acid metal salt, and a Lewis acid.

In the curable composition of the present invention, the ratio of the main agent and the curing agent blended is not particularly limited, and can be appropriately adjusted depending on the desired properties of the cured product and the use purpose. As an example of blending, the total of acid anhydride groups of the acid anhydride (B) in the curing agent is preferably in the range of 0.5 to 1.05 moles per mole of the epoxy groups of the epoxy resin component in the main agent.

In addition, when the other curing agent or curing promotor (B′) is used, the blending ratio is not particularly limited, and can be appropriately adjusted depending on the desired properties of the cured product and the use purpose. In particular, the other curing agent is preferably blended in a proportion of 0.1 to 30% by mass in the curable composition. The other curing agent or curing promotor (B′) may be blended in the curing agent together with the acid anhydride (B), or may be added at the time when the main agent and the curing agent are blended.

The curable composition of the present invention may contain another resin component or various additives in one or both of the main agent and the curing agent. Examples of the other resin component include an acid-modified polybutadiene, a polyether sulfone resin, a polycarbonate resin, and a polyphenylene ether resin.

An example of the acid-modified polybutadiene is one obtained by modifying polybutadiene with an unsaturated carboxylic acid. In addition, as a commercial product, a maleic anhydride-modified liquid polybutadiene (Polyvest MA75, Polyvest EP MA120, or the like) manufactured by Evonik Degussa, a maleic anhydride-modified polyisoprene (LIR-403 or LIR-410) manufactured by Kuraray Co., Ltd., or the like can be used.

Examples of the polycarbonate resin include a polycondensation product of a divalent or bifunctional phenol and a halogenated carbonyl and one obtained by polymerizing a divalent or bifunctional phenol and a carbonate diester by a transesterification method. In addition, the polycarbonate resin may be one in which the molecular structure of the polymer chain is a linear structure or may have a branched structure.

The polyphenylene ether resin may be a modified polyphenylene ether resin in which a reactive functional group, such as a carboxy group, an epoxy group, an amino group, a mercapto group, a silyl group, a hydroxy group, or an anhydrous dicarboxy group, is introduced into the resin structure by any method, such as grafting reaction or copolymerization.

Examples of the various additives include a flame retardant or auxiliary flame retardant, a filler, another additive, and an organic solvent. Examples of the flame retardant or auxiliary flame retardant include a phosphorus-based flame retardant, a nitrogen-based flame retardant, a silicone-based flame retardant, a metal hydroxide, a metal oxide, a metal carbonate salt compound, a metal powder, a boron compound, a low melting point glass, ferrocene, an acetylacetonato metal complex, an organic metal carbonyl compound, an organic cobalt salt compound, an organic sulfonic acid metal salt, and a compound obtained by binding a metal atom and an aromatic compound or a heterocyclic compound via an ionic bond or a coordinate bond. The additives may each be used alone or two or more thereof may be used in combination.

Examples of the filler include a fibrous reinforcing agent, such as titanium oxide, glass bead, glass flake, glass fiber, calcium carbonate, barium carbonate, calcium sulfate, barium sulfate, potassium titanate, aluminum borate, magnesium borate, fused silica, crystalline silica, alumina, silicon nitride, aluminum hydroxide, kenaf fiber, carbon fiber, alumina fiber, or quartz fiber, and a non-fibrous reinforcing agent. The fillers may each be used alone or two or more thereof may be used in combination. In addition, the fillers may be coated with an organic material or an inorganic material.

In addition, when a glass fiber is used as a filler, one selected from a long filament-type roving, a short filament-type chopped strand, a milled fiber, and the like can be used. As a glass fiber, one surface-treated for a resin to be used is preferably used. By blending a filler, the strength of a nonflammable layer (or char layer) produced on combustion can further be increased. The nonflammable layer (or char layer) once produced on combustion becomes less likely to be broken, and stable thermal insulation ability can be exhibited, and a higher flame retardant effect can be obtained. Furthermore, high rigidity can be imparted to materials.

Examples of the other additive include a plasticizer, an antioxidant, a UV absorber, a stabilizer such as a photostabilizer, an antistatic agent, a conductivity improver, a stress relaxation agent, a mold release agent, a crystallization accelerator, a hydrolysis inhibitor, a lubricant, an impact imparting agent, a slidability improver, a compatibilizer, a nucleating agent, a toughening agent, a reinforcing agent, a fluidity modifier, a dye, a sensitizer, a coloring pigment, a rubber-like polymer, a thickener, an antisetting agent, an antisagging agent, a defoaming agent, a coupling agent, an antirust agent, an antimicrobial and fungicidal agent, an antifouling agent, and a conductive polymer.

The organic solvent is useful, for example, for producing a fiber-reinforced resin molded article by a filament winding method using the curable composition of the present invention. The type and amount of the organic solvent added is not particularly limited, and are appropriately selected according to the solubility of various compounds contained in the curable composition of the present invention, the workability in a molding step, and the like. Examples thereof include methyl ethyl ketone acetone, dimethylformamide, methyl isobutyl ketone, methoxypropanol, cyclohexanone, methyl cellosolve, ethyldiglycol acetate, and propylene glycol monomethyl ether acetate.

The curable composition of the present invention can be used for various applications, such as for a paint, an electric or electronic material, an additive, a molded article, and the like. The curable composition of the present invention can be suitably used not only for applications in which the curable composition itself is cured and then used but also for a fiber-reinforced composite material or a fiber-reinforced resin molded article.

Any method can be used for obtaining a cured product from the curable composition of the present invention as long as the method is based on an ordinary method for curing an epoxy resin composition, and, for example, a heating temperature condition may be appropriately selected according to the type of the curing agent combined thereto and the use purpose. An example is a method in which the curable composition is heated at a temperature in the range of a room temperature to about 250° C. As a molding method or the like, an ordinary method for a curable composition can be used, and any condition specific to the curable composition of the present invention is not particularly required.

The fiber-reinforced composite material of the present invention is a material in the state after infiltrating the curable composition into a reinforcing fiber and before curing. Here, the reinforcing fiber may be any of a twisted yarn, an untwisted yarn, and a non-twisted yarn, but an untwisted yarn or a non-twisted yarn is preferred because of providing a fiber-reinforced composite material excellent in moldability. Furthermore, as a form of the reinforcing fiber, one in which fibers are uniformly arranged by pulling in one direction or a textile fabric can be used. The textile fabric can be freely selected from plain weave, satin weave, and the like according to the part in which it is used and the use purpose. Specific examples of the reinforcing fiber include a carbon fiber, a glass fiber, an aramid fiber, a boron fiber, an alumina fiber, and a silicon carbide fiber because of excellent mechanical strength and durability, and two or more thereof may be used in combination. Among them, in terms of providing a molded article having high strength, a carbon fiber is preferred, and various carbon fibers, such as a polyacrylonitrile-based one, a pitch-based one, and a rayon-based one, can be used.

A method for producing a fiber-reinforced composite material from the curable composition of the present invention is not particularly limited, and examples include a method in which the components constituting the curable composition are uniformly mixed to adjust a vanish, and then, a unidirectional reinforcing fiber obtained by uniformly arranging reinforcing fibers by pulling in one direction is immersed in the obtained vanish (a state before curing in a pultrusion method or a filament winding method) and a method in which sheets of a textile fabric of a reinforcing fiber are superimposed and set in a concave mold, which is then sealed with a convex mold, and then, a resin is injected therein and is infiltrated with pressure (a state before curing in a RTM method).

The carbon fiber is not particularly limited, but from the viewpoint of mechanical strength and rigidity, one having a tensile strength in the range of 3,000 MPa to 7,000 MPa, a tensile elongation in the range of 1.5 to 2.3%, and a tensile elasticity of 200 MPa or more is preferred. Furthermore, one having a tensile strength in the range of 4,500 MPa to 6,500 MPa, a tensile elongation in the range of 1.7 to 2.3%, and a tensile elasticity of 230 MPa or more is more preferred. Here, examples of a commercial carbon fiber product include “TORAYCA (registered tradename)” T800S-24000, “TORAYCA (registered tradename)” T700SC-12000, “TORAYCA (registered tradename)” T700SC-24000, and “TORAYCA (registered tradename)” T300-3000.

In addition, a carbon fiber strand preferably has a number of filaments in one fiber strand in the range of 3,000 to 50,000. When the number of filaments is less than 3000, the fiber is likely to bend, which may cause lowering of the strength. In contrast, with a number of filaments of 50,000 or more, poor infiltration of the resin is likely to occur, and thus, the number of filaments is more preferably 5,000 to 40,000.

Furthermore, the fiber-reinforced composite material of the present invention preferably has a volume content of the reinforcing fiber of 40% to 85% based on the total volume of the fiber-reinforced composite material, and in terms of the strength, the volume content is further preferably in the range of 50% to 70%. When the volume content is less than 40%, the content of the curable composition is too high, and thus the flame retardancy of a resulting cured product is short or various properties required for a fiber-reinforced composite material excellent in specific modulus and specific strength cannot be satisfied in some cases. In addition, when the volume content exceeds 85%, adhesiveness between the reinforcing fiber and the resin composition may be lowered.

The fiber-reinforced resin molded article of the present invention is a molded article including a reinforcing fiber and a cured product of the curable composition, and can be obtained by curing with heat the fiber-reinforced composite material. In the fiber-reinforced resin molded article of the present invention, specifically, the volume content of a reinforcing fiber in the fiber-reinforced molded article is preferably in the range of 40% to 85%, and from the viewpoint of strength, the volume content is particularly preferably in the range of 50% to 70%. Examples of such a fiber-reinforced resin molded article include vehicle components, such as a front subframe, a rear subframe, a front pillar, a center pillar, a side member, a cross member, a side sill, a roof rail, and a propeller shaft, and a core member of an electric wire cable, a pipe material for offshore oilfield, a roll/pipe material for printer, a robot fork material, and a primary structural material and secondary structural material for aircraft.

A method for producing a fiber-reinforced molded article from the curable composition of the present invention is not particularly limited, and a drawing molding method (pultrusion method), a filament winding method, an RTM method, or the like is preferably used. The drawing molding method (pultrusion method) is a method in which a fiber-reinforced composite material is introduced in a mold, is cured with heat, and then is drawn with a drawing apparatus to mold a fiber-reinforced resin molded article. The filament winding method is a method in which a fiber-reinforced composite material (including a unidirection fiber) is wound on an aluminum liner or plastic liner which is rotating, and is cured with heat to mold a fiber-reinforced resin molded article. The RTM method is a method using two molds of a convex shape and a concave shape in which a fiber-reinforced composite material is cured with heat in the molds to mold a fiber-reinforced resin molded article. Note that when a fiber-reinforced resin molded article which is a large product or which has a complex shape is molded, the RTM method is preferably used.

As a condition in molding a fiber-reinforced resin molded article, a fiber-reinforced composite material is preferably molded by curing it with heat at a temperature in the range of 50° C. to 250° C., and more preferably at a temperature in the range of 70° C. to 220° C. When the molding temperature is too low, sufficiently rapid curing may not be achieved. In contrast, when the temperature is too high, a warp due to heat strain may be likely to occur. As another molding condition, a method of two-step curing, for example, in which a fiber-reinforced composite material is pre-cured at 50° C. to 100° C. to obtain a tack-free cured product, which is then further treated at a temperature condition at 120° C. to 200° C. can be exemplified.

Other examples of a method for producing a fiber-reinforced molded article from the curable composition of the present invention include a vacuum bag method including layering the vanish as described above and a substrate of a reinforcing fiber, molding the layers while infiltrating the vanish into the substrate by using any one of a hand lay-up method, a spray up method, or male and female molds in which a fibrous aggregate is spread on a mold and the vanish and fibrous aggregate are layered into a multilayer, and then molding the vanish and the substrate under vacuum (reduced pressure) with a flexible mold placed thereon and airtightly sealed, which flexible mold can apply a pressure on a molded article; and a SMC press method including preliminary forming a sheet from the vanish containing a reinforcing fiber and compression-molding the sheet with a mold.

### EXAMPLES

Next, the present invention will be more specifically described based on Examples and Comparative Examples.

Hereinafter, “parts” and “%” are based on mass unless otherwise specified.

### Production Example 1: Production of Urethane-Modified Epoxy Resin (A-1)

Into a four-neck flask equipped with a nitrogen introducing tube, a condenser, a thermometer, and a stirrer, 80 parts by mass of isophorone diisocyanate was put and heated to 80° C. Next, as a polyether polyol, 447 parts by mass of SANNIX PP-2000 (number average molecular weight: 2000) manufactured by Sanyo Chemical Industries Ltd. was added. Then, 0.1 parts by mass of a urethanation catalyst (“NEOSTANN U-28”) manufactured by Nitto Kasei Co., Ltd. was added and the mixture was reacted for additional 2 hours to obtain an intermediate (1) having an isocyanate group content of 2.1% by mass.

Next, as a bisphenol A-type epoxy resin, 940 parts by mass of EPICLON 850-S (epoxy equivalent: 188 g/equivalent, hydroxy group equivalent: 2900 g/equivalent) manufactured by DIC Corporation was added and the mixture was reacted under a temperature condition of 80° C. until extinction of the isocyanate group was confirmed, thus obtaining a urethane-modified epoxy resin (A-1). The urethane-modified epoxy resin (A-1) had an epoxy equivalent of 293 g/eq.

### Production Examples 2 to 10: Production of Urethane-Modified Epoxy Resins (A-2) to (A-10)

Urethane-modified epoxy resins (A-2) to (A-10) were obtained in the same manner as in Production Example 1 except that the raw materials used were changed to those shown in Table 1. Note that, in Production Example 10, a bisphenol A-type epoxy resin EPICLON 850-S manufactured by DIC corporation and a 1,4-butanediol-type epoxy resin EX-214 manufactured by Nagase ChemteX Corporation were used in combination for reaction.

TABLE 1

| | Production Example | | | | | | | | | |
|---|---|---|---|---|---|---|---|---|---|---|
| | 1 | 2 | 3 | 4 | 5 | 6 | 7 | 8 | 9 | 10 |
| Epoxy resin | A-1 | A-2 | A-3 | A-4 | A-5 | A-6 | A-7 | A-8 | A-9 | A-10 |
| IPDI | 80 | 80 | 80 | 80 | 80 | 80 | 80 | 80 | | |
| TDI | | 62.6 | | | | | | | | 62.6 |
| PP 2000 | 447 | 447 | | | | | | | | 447 |
| PP 1000 | | | 223 | 180 | 270 | | | | | |
| PTMG 2000 | | | | | | 447 | | | | |
| PEG 2000 | | | | | | | 447 | | | |
| PEG 400 | | | | | | | | 89.5 | | |
| P 3000 | | | | | | | | | 454 | |
| 850-S | 940 | 954 | 941 | 1212 | 690 | 940 | 940 | 941 | 941 | 954 |
| EX-214 | | | | | | | | | | 585 |
| EE (g/e1) | 293 | 288 | 249 | 228 | 283 | 293 | 293 | 222 | 295 | 219 |

### Compounds in Table 1

IPDI: isophorone diisocyanate “VESTANAT IPDI” manufactured by Evonik Japan
TDI: tolylene diisocyanate “COSMONATE T-80” manufactured by Mitsui Chemicals Inc.
PP 2000: polyoxypropylene glycol “SANNIX PP-2000” manufactured by Sanyo Chemical Industries Ltd., hydroxyl value: 56.1 mgKOH/g, number average molecular weight: 2,000
PP 1000: polyoxypropylene glycol “SANNIX PP-1000” manufactured by Sanyo Chemical Industries Ltd., hydroxyl value: 109 mgKOH/g, number average molecular weight: 1,030
PTMG 2000: polyoxytetramethylene glycol “PTMG 2000” manufactured by Mitsubishi Chemical Corporation, hydroxyl value: 56.7 mgKOH/g, number average molecular weight: 1,980
PEG 2000: polyoxyethylene glycol “PEG#2000” manufactured by NOF CORPORATION, hydroxyl value: 56.3 mgKOH/g, average molecular weight: 1,990
PEG 400: polyoxyethylene glycol “PEG#400” manufactured by NOF CORPORATION, hydroxyl value: 282 mgKOH/g, average molecular weight: 400
GP 3000: polyoxypropylene glycol “GP-3000” manufactured by Sanyo Chemical Industries Ltd., hydroxyl value: 55.7 mgKOH/g, number average molecular weight: 3,020
850-S: bisphenol A-type epoxy resin manufactured by DIC Corporation, epoxy equivalent: 188 g/equivalent, hydroxy group equivalent: 2900 g/equivalent
EX-214: 1,4-butane diol-type epoxy resin manufactured by Nagase ChemiteX Corporation, epoxy equivalent: 137 g/equivalent, hydroxy group equivalent: 1460 g/equivalent

### Examples 1 to 11, Comparative Example 1

Components were blended according to the formulation shown in Tables 2 to 3 below and were uniformly mixed with stirring, thus obtaining a curable composition. The curable composition was subjected to various evaluation tests according to the following procedures. The results are shown in Table 2.

The details of the components used in Examples and Comparative Examples are as follows.

Epoxy resin (C-1): “DENACOL EX-214” manufactured by Nagase Chemitex Corporation, 1,4-butane diol-type epoxy resin, epoxy equivalent: 137 g/equivalent,
Bisphenol-type epoxy resin: “EPICLON 850-S” manufactured by DIC Corporation, epoxy equivalent: 188 g/equivalent
Acid anhydride (B-1): methyltetrahydrophthalic anhydride (“EPICLON B-570-H” manufactured by DIC Corporation)
Acid anhydride (B-2): methylhexahydrophthalic anhydride (“HN-5500” manufactured by Hitachi Chemical Company, Ltd.)
Curing promotor: N,N-dimethylbenzylamine

### Measurement of Fracture Toughness

A curable composition was poured in a mold frame of 200 mm X 100 mm×6 mm, and was cured with heat at 120° C. for 2 hours and then at 140° C. for 2 hours, thus obtaining a cured product. The obtained cured product was measured for K_{IC} value according to ASTM D 5045.

### Measurement of Elongation

A curable composition was poured in a mold frame of 200 mm×100 mm×4 mm, and was cured with heat at 120° C. for 2 hours and then at 140° C. for 2 hours, thus obtaining a cured product. The obtained cured product was subjected to a tensile test according to JIS K7162 to measure the elongation.

### Measurement of Tensile Strength

A carbon fiber (“T700SC-12,000” manufactured by Toray Industries, Inc.) was wound while infiltrating a curable composition therein using a filament winding apparatus, and the curable composition was cured with heat at 120° C. for 2 hours and then at 140° C. for 2 hours, thus obtaining a fiber-reinforced resin molded article having a fiber volume content (Vf) of 60% and a thickness of 2 mm. This plate was cut and subjected to a tensile test according to JIS K7165.

TABLE 2

| | Ex- | Ex- | Ex- | Ex- | Ex- | Ex- |
|---|---|---|---|---|---|---|
| | ample | ample | ample | ample | ample | ample |
| | 1 | 2 | 3 | 4 | 5 | 6 |
| (A-1) | 41 | | | | | |
| (A-2) | | 41 | | | | |
| (A-3) | | | 39 | | | |
| (A-4) | | | | 38 | | |
| (A-5) | | | | | 40 | |
| (A-6) | | | | | | 41 |
| (A-7) | | | | | | |
| (A-8) | | | | | | |
| (A-9) | | | | | | |
| (A-10) | | | | | | |
| Epoxy resin | 16 | 16 | 16 | 15 | 16 | 16 |
| (C-1) | | | | | | |
| Bisphenol-type | | | | | | |
| epoxy resin | | | | | | |
| Acid anhydride | 43 | 43 | 45 | 46 | 43 | 43 |
| (B-1) | | | | | | |
| Acid anhydride | | | | | | |
| (B-2) | | | | | | |
| Curing promotor | 1 | 1 | 1 | 1 | 1 | 1 |
| Fracture | 1.25 | 1.2 | 0.82 | 0.7 | 0.95 | 1.19 |
| toughness | | | | | | |
| (K_{IC}) [MPa/m^{1/2}] | | | | | | |
| Elongation [%] | 13.2 | 12.7 | 12 | 8.5 | 8 | 14 |
| Tensile strength | 2,190 | 2,100 | 2,080 | 2,070 | 2,110 | 2,150 |
| [MPa] | | | | | | |

TABLE 3

| | | | | | | Com- |
|---|---|---|---|---|---|---|
| | Ex- | Ex- | Ex- | Ex- | Ex- | parative |
| | ample | ample | ample | ample | ample | Ex- |
| | 7 | 8 | 9 | 10 | 11 | ample 1 |
| (A-1) | | | | | | |
| (A-2) | | | | | 41 | |
| (A-3) | | | | | | |
| (A-4) | | | | | | |
| (A-5) | | | | | | |
| (A-6) | | | | | | |
| (A-7) | 41 | | | | | |
| (A-8) | | 38 | | | | |
| (A-9) | | | 41 | | | |
| (A-10) | | | | 57 | | |
| Epoxy resin | 16 | 15 | 16 | | 16 | |
| (C-1) | | | | | | |
| Bisphenol- | | | | | | 53 |
| type | | | | | | |
| epoxy resin | | | | | | |
| Acid | 43 | 47 | 43 | 43 | | 47 |
| anhydride | | | | | | |
| (B-1) | | | | | | |
| Acid | | | | | 43 | |
| anhydride | | | | | | |
| (B-2) | | | | | | |
| Curing | 1 | 1 | 1 | 1 | 1 | 1 |
| promotor | | | | | | |
| Fracture | 1.03 | 0.72 | 0.94 | 1.22 | 1.12 | 0.55 |
| toughness | | | | | | |
| (K_{IC}) | | | | | | |
| [MPa/m^{1/2}] | | | | | | |
| Elongation | 7.5 | 7.9 | 6.3 | 12.9 | 10.2 | 4.8 |
| [%] | | | | | | |
| Tensile | 2,180 | 2,080 | 2,110 | 2,090 | 2,180 | 1,970 |
| strength | | | | | | |
| [MPa] | | | | | | |

1. . A curable composition comprising a urethane-modified epoxy resin (A) as an essential component of a main agent and an acid anhydride (B) as an essential component of a curing agent, the urethane-modified epoxy resin (A) being a reaction product obtained by using a polyisocyanate compound (a1), a polyether polyol (a2), and a hydroxy group-containing epoxy resin (a3) as essential reaction materials.

2. The curable composition according to claim 1, wherein the polyether polyol (a2) is a polyether diol having a number average molecular weight (Mn) of 500 to 4,000.

3. The curable composition according to claim 1, wherein the polyether polyol (a2) has a content of a polyether diol of 80% by mass or more.

4. The curable composition according to claim 1, wherein the polyisocyanate compound (a1) has an isocyanate group content of 35% by mass or more.

5. The curable composition according to claim 1, wherein a proportion of the urethane-modified epoxy resin (A) based on a total mass of an epoxy resin component contained in the main agent is in the range of 30 to 100% by mass.

6. The curable composition according to claim 1, wherein the main agent contains an aliphatic epoxy resin besides the urethane-modified epoxy resin (A).

7. The curable composition according to claim 6, wherein a ratio by mass of the urethane-modified epoxy resin (A) to the aliphatic epoxy resin [urethane-modified epoxy resin (A)/aliphatic epoxy resin] is in the range of 30/70 to 100/0.

8. The curable composition according to claim 1, wherein the acid anhydride (B) is methyltetrahydrophthalic anhydride, methylhexahydrophthalic annydride, or methyl-end-ethylene tetrahydrophthalic anhydride.

9. The curable composition according to claim 1, further comprising a curing promotor (C).

10. A cured product of the curable composition according to claim 1.

11. A fiber-reinforced composite material comprising the curable composition according to claim 1 and a reinforcing fiber as essential components.

12. A fiber-reinforced resin molded article comprising the cured product according to claim 10 and a reinforcing fiber as essential components.

13. A method for producing a fiber-reinforced resin molded article, the method comprising curing with heat the fiber-reinforced composite material according to claim 12.

14. The curable composition according to claim 2, wherein the acid anhydride (B) is methyltetrahydrophthalic anhydride, methylhexahydrophthalic annydride, or methyl-end-ethylene tetrahydrophthalic anhydride.

15. The curable composition according to claim 3, wherein the acid anhydride (B) is methyltetrahydrophthalic anhydride, methylhexahydrophthalic annydride, or methyl-end-ethylene tetrahydrophthalic anhydride.

16. The curable composition according to claim 2, further comprising a curing promotor (C).

17. The curable composition according to claim 3, further comprising a curing promotor (C).

18. A cured product of the curable composition according to claim 2.

19. A cured product of the curable composition according to claim 3.

20. A fiber-reinforced composite material comprising the curable composition according to claim 2 and a reinforcing fiber as essential components.
